(19) United States
(12) Patent Application Publication
(10) Pub. No.: US 2018/0179951 A1
(43) Pub. Date: Jun. 28, 2018

(54) ROTATING DETONATION ENGINE INCLUDING SUPPLEMENTAL COMBUSTOR AND METHOD OF OPERATING SAME

(71) Applicant: General Electric Company, Schenectady, NY (US)

(72) Inventors: Venkat Eswarlu Tangirala, Niskayuna, NY (US); Keith Robert McManus, Clifton Park, NY (US); Michael Bowman, Niskayuna, NY (US); Narendra Joshi, Schenectady, NY (US); Joel Haynes, Niskayuna, NY (US); Anthony Dean, Scotia, NY (US)

(21) Appl. No.: 15/390,112

(22) Filed: Dec. 23, 2016

(51) Int. Cl. F02C 3/16; F02C 3/04; F02C 3/34

(52) U.S. Cl. CPC F02C 3/16; F02C 3/04; F05D 2240/35; F05D 2220/32; F02C 3/34

(57) ABSTRACT

A turbine engine includes at least one compressor configured to increase pressure of a fluid flow and a primary combustor coupled in flow communication with the at least one compressor. The primary combustor is configured to receive pressurized fluid flow from the at least one compressor. The primary combustor includes a housing defining at least one combustion chamber. The primary combustor is configured for a rotating detonation process to occur within said at least one combustion chamber. The turbine engine also includes at least one supplemental combustor coupled in flow communication with the primary combustor. The at least one supplemental combustor is configured to receive combustion products and perform a combustion operation. The turbine engine further includes a turbine assembly coupled in flow communication with the at least one supplemental combustor. The turbine assembly is configured to receive combustion products from the at least one supplemental combustor.

### BACKGROUND

The field of the invention relates generally to turbine engines, and more particularly, to rotating detonation turbine engines including supplemental combustors.

In rotating detonation engines and, more specifically, in rotating detonation combustors, a mixture of fuel and an oxidizer is ignited such that combustion products are formed. For example, the combustion process begins when the fuel-oxidizer mixture in a tube or a pipe structure is ignited via a spark or another suitable ignition source to generate a compression wave. The compression wave is followed by a chemical reaction that transitions the compression wave to a detonation wave. The detonation wave enters a combustion chamber of the rotating detonation combustor and travels along the combustion chamber. Air and fuel are separately fed into the rotating detonation combustion chamber and are consumed by the detonation wave. As the detonation wave consumes air and fuel, combustion products traveling along the combustion chamber accelerate and are discharged from the combustion chamber. In at least some rotating detonation combustors, gases such as nitrogen oxides and carbon monoxide are emitted during the combustion process and reduce the efficiency of the rotating detonation engines.

### BRIEF DESCRIPTION

In one aspect, a turbine engine is provided. The turbine engine includes at least one compressor configured to increase pressure of a fluid flow and a primary combustor coupled in flow communication with the at least one compressor. The primary combustor is configured to receive pressurized fluid flow from the at least one compressor. The primary combustor includes a housing defining at least one combustion chamber. The primary combustor is configured for a rotating detonation process to occur within said at least one combustion chamber. The turbine engine also includes at least one supplemental combustor coupled in flow communication with the primary combustor. The at least one supplemental combustor is configured to receive combustion products and perform a combustion operation. The turbine engine further includes a turbine assembly coupled in flow communication with the at least one supplemental combustor. The turbine assembly is configured to receive combustion products from the at least one supplemental combustor.

In another aspect, a power generation system is provided. The power generation system includes at least one compressor configured to increase pressure of a fluid flow and a primary combustor coupled in flow communication with the at least one compressor. The primary combustor is configured to receive pressurized fluid flow from the at least one compressor. The primary combustor includes a housing defining at least one combustion chamber. The primary combustor is configured for a rotating detonation process to occur within the at least one combustion chamber. The power generation system also includes a first turbine coupled in flow communication with the primary combustor. The first turbine is configured to receive combustion flow from the primary combustor. The power generation system further includes at least one supplemental combustor coupled in flow communication with the first turbine. The at least one supplemental combustor is configured to receive exhaust flow from the first turbine and perform a combustion operation. The power generation system also includes a second turbine coupled in flow communication with the at least one supplemental combustor. The turbine is configured to receive combustion flow from the at least one supplemental combustor.

In another aspect, a method of operating a turbine engine including a primary combustor and a supplemental combustor is provided. The method includes directing a pressurized fluid flow into at least one combustion chamber of the primary combustor and initiating a rotating detonation process within the at least one combustion chamber. The method also includes directing combustion products from the at least one combustion chamber of the primary combustor toward at least one combustion chamber of the supplemental combustor and initiating a combustion process within the at least one combustion chamber of the supplemental combustor. The method further includes directing combustion products from the at least one combustion chamber of the supplemental combustor toward a turbine assembly of the turbine engine.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an exemplary combined cycle power generation system;

FIG. 2 is a sectional schematic view of a primary combustor of the combined cycle power generation system shown in FIG. 1;

FIG. 3 is a sectional schematic view of a supplemental combustor of the combined cycle power generation system shown in FIG. 1; and

FIG. 4 is an exemplary graphical view of temperature vs. entropy for the power generation system shown in FIG. 1.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations are combined and interchanged; such ranges are identified and include all the sub-ranges contained therein unless context or language indicates otherwise.

The systems and methods described herein provide a turbine engine including a primary combustor and a supplemental combustor. The primary combustor includes a detonation chamber for rotating detonation combustion. In particular, during operation, detonations continuously travel around the detonation chamber and produce near constant volume combustion within the detonation chamber of the primary combustor. The supplemental combustor receives combustion products from the primary combustor and performs a supplemental combustion process. As a result, the combustion efficiency of the turbine engine is increased because the supplemental combustor processes unburnt fuel in the combustion products emitted by the primary combustor.

As used herein, a “detonation chamber” refers to any combustion device or system where a series of repeating detonations or quasi-detonations within the device cause a pressure rise and subsequent acceleration of the combustion products as compared to the pre-burned reactants. A “quasi-detonation” is a combustion process that produces a pressure rise and velocity increase higher than the pressure rise produced by a deflagration wave. Throughout this disclosure, the terms “detonation” and “quasi-detonation” are used interchangeably. Typical embodiments of detonation chambers include a means of igniting a fuel/oxidizer mixture, for example a fuel/air mixture, and a confining chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, autoignition or by another detonation via cross-firing. The geometry of the detonation chamber is such that the pressure rise of the detonation wave expels combustion products out the detonation chamber exhaust to produce a thrust force. In addition, rotating detonation combustors are designed such that a substantially continuous detonation wave is produced and discharged therefrom. As known to those skilled in the art, detonation may be accomplished in a number of types of detonation chambers, including detonation tubes, shock tubes, resonating detonation cavities, and annular detonation chambers.

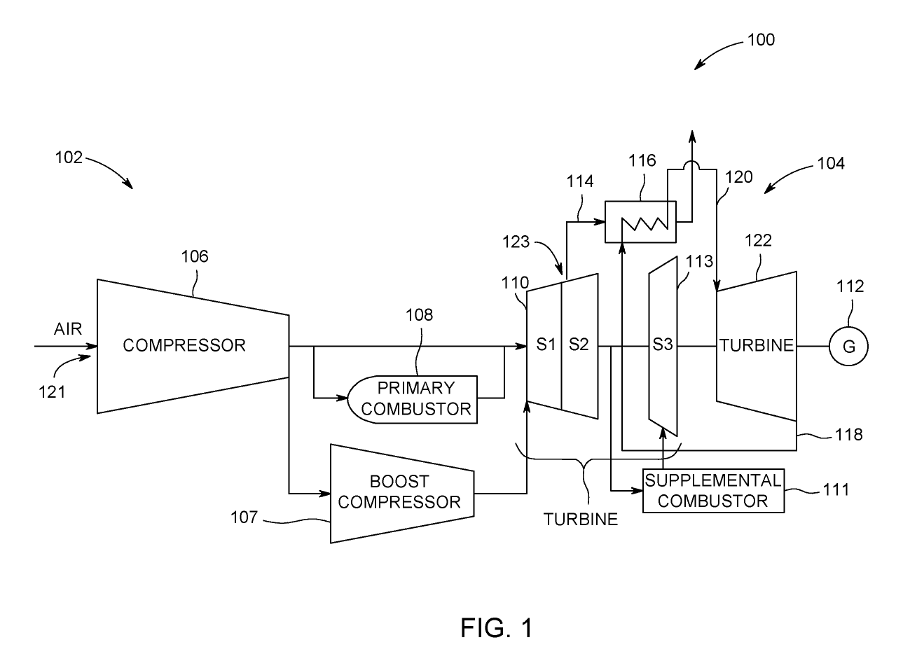

FIG. 1 is a schematic illustration of an exemplary combined cycle power generation system 100. Power generation system 100 includes a gas turbine engine assembly 102, and a steam turbine engine assembly 104. Gas turbine engine assembly 102 includes a compressor 106, a boost compressor 107, a primary combustor 108, a first turbine 110, a second turbine 113, and a supplemental combustor 111. First turbine 110 is powered by expanding hot gas produced in primary combustor 108 for driving an electrical generator 112. Gas turbine engine assembly 102 may be used in a stand-alone simple cycle configuration for power generation or mechanical drive applications. In the exemplary embodiment, exhaust gas 114 is channeled from first turbine 110 towards a heat recovery steam generator (HRSG) 116 for recovering waste heat from exhaust gas 114. More specifically, HRSG 116 transfers heat from exhaust gas 114 to water/steam 118 channeled through HRSG 116 to produce steam 120. Steam turbine engine assembly 104 includes a steam turbine 122 that receives steam 120, which powers steam turbine 122 for further driving electrical generator 112.

In operation, air enters gas turbine engine assembly 102 through an intake 121 and is channeled through multiple stages of compressor 106 towards primary combustor 108. Compressor 106 compresses the air and the highly compressed air is channeled from compressor 106 towards primary combustor 108 and mixed with fuel. The fuel-air mixture is combusted within primary combustor 108. High temperature combustion gas generated by primary combustor 108 is channeled towards first turbine 110. In addition, highly compressed air from compressor 106 is directed towards boost compressor 107. The highly compressed air is further compressed and channeled towards first turbine 110. Exhaust gas 114 is subsequently discharged from first turbine 110 through exhaust 123 and channeled towards HRSG 116 and supplemental combustor 111. Fuel is provided to supplemental combustor 111 and the fuel and air are combusted within supplemental combustor 111. Combustion gas generated by supplemental combustor 111 is channeled towards second turbine 113.

In the exemplary embodiment, supplemental combustor 111 is coupled between first turbine 110 and second turbine 113. Accordingly, combustion products from primary combustor 108 are channeled through first turbine 110 towards supplemental combustor 111. In alternative embodiments, supplemental combustor 111 is positioned anywhere that enables power generation system 100 to operate as described herein. For example, in some embodiments, supplemental combustor 111 is coupled between primary combustor 108 and first turbine 110. In further embodiments, supplemental combustor 111 is coupled to primary combustor 108 to form a combustor assembly.

Also, in the exemplary embodiment, first turbine 110 is a multi-stage turbine including at least a first stage and a second stage. First turbine 110 and second turbine 113 are coupled together to form a turbine assembly. First turbine 110 acts as a high pressure turbine and second turbine 113 acts as a low pressure turbine. In alternative embodiments, power generation system 100 includes any turbine that enables power generation system 100 to operate as described herein.

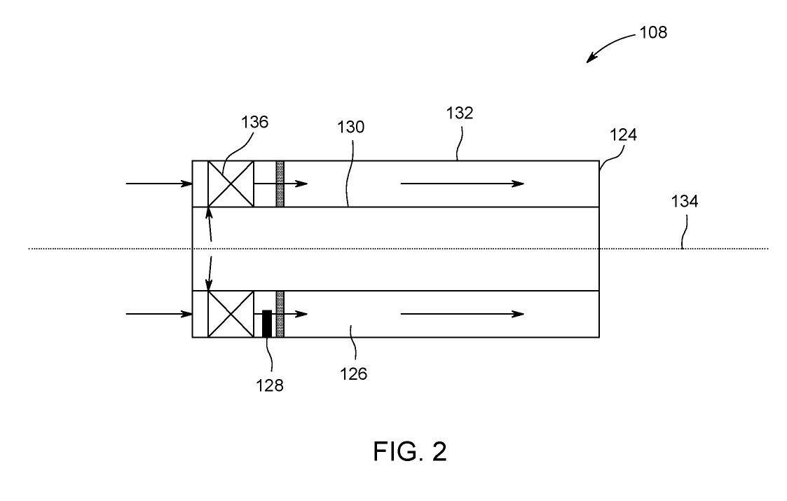

FIG. 2 is a sectional schematic view of primary combustor 108. In the exemplary embodiment, primary combustor 108 includes a housing 124 defining a combustion chamber 126. In addition, primary combustor 108 includes an ignitor 128, broadly an initiator. Ignitor 128 is used to initiate a rotating detonation process within combustion chamber 126. Accordingly, combustion chamber 126 is a detonation chamber. In alternative embodiments, primary combustor 108 includes any initiator that enables primary combustor 108 to operate as described herein. In some embodiments, primary combustor 108 includes a spark and/or plasma ignitor. In further embodiments, primary combustor 108 includes a predetonation initiator.

In the exemplary embodiment, housing 124 includes a radially inner side wall 130 and a radially outer side wall 132 that both extend circumferentially relative to a longitudinal axis 134 of primary combustor 108. Combustion chamber 126 is defined between radially inner side wall 130 and radially outer side wall 132. As such, combustion chamber 126 is annular. In alternative embodiments, primary combustor 108 includes any combustion chamber 126 that enables primary combustor 108 to operate as described herein. In further embodiments, combustion chamber 126 is any suitable geometric shape and does not necessarily include an inner liner and/or central body. For example, in some embodiments, combustion chamber 126 is substantially cylindrical.

Also, in the exemplary embodiment, combustion chamber 126 is configured to receive airflow, broadly an oxidizer flow, and a fuel flow. In some embodiments, combustion chamber 126 is configured to receive a cooling flow to cool combustion chamber 126. For example, in some embodiments, both oxidizer flow and cooling flow are supplied by bleed air from compressor 106 (shown in FIG. 1). As used herein, the term “air” refers to an oxidizer. For example, in some embodiments, air includes oxygen and/or compressed air. A few examples of fuel types include, without limitation, hydrogen, distillate fuel, and natural gas. In alternative embodiments, combustion chamber 126 is configured to receive any flow that enables primary combustor 108 to operate as described herein.

In addition, in the exemplary embodiment, primary combustor 108 further includes a fuel-air mixing element 136 to provide a fuel-air mixture to combustion chamber 126. In some embodiments, a regulating component, such as a high frequency fuel control valve, regulates fuel and/or oxygen flow to fuel-air mixing element 136. In alternative embodiments, combustion chamber 126 includes any mixing element that enables primary combustor 108 to operate as described herein. For example, in some embodiments, primary combustor 108 includes, without limitation, any of the following: a hypermixer, a swirler, a cavity, and any other mixing element.

During operation, compressor 106 provides compressed gas to primary combustor 108. Primary combustor 108 receives the compressed gas and performs a combustion process. In particular, ignitor 128 initiates a rotating detonation combustion process. In some embodiments, ignitor 128 is any of a pulse detonation tube, a strong spark, and a plasma initiator. During the rotating detonation combustion process, detonations or quasi-detonations continuously travel about combustion chamber 126. As a result, pressure is rapidly elevated within combustion chamber 126 before a substantial amount of gas escapes from combustion chamber 126. Accordingly, primary combustor 108 provides inertial confinement to produce near constant volume combustion during operation.

In reference to FIGS. 1 and 2, in the exemplary embodiment, compressor 106 has a reduced number of compressor stages because primary combustor 108 increases the pressure of the pressurized air during the rotating detonation process. For example, in the exemplary embodiment, compressor 106 includes 10 to 12 stages. However, the pressurized air moving through power generation system 100 has a pressure equivalent to the pressure of airflow through at least some systems that include compressors having more stages because primary combustor 108 increases the pressure of the pressurized air. In alternative embodiments, compressor 106 includes any stage that enables power generation system 100 to operate as described herein.

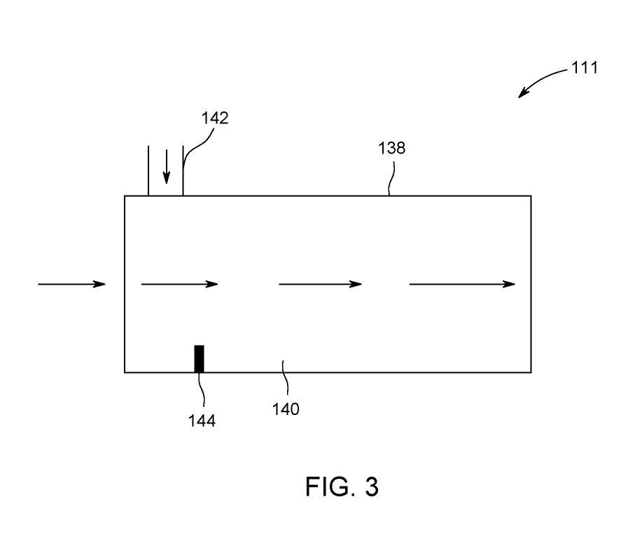

FIG. 3 is a sectional schematic view of supplemental combustor 111. Supplemental combustor 111 includes a housing 138 defining a combustion chamber 140. Supplemental combustor 111 is configured to perform a combustion operation within combustion chamber 140. In particular, in the exemplary embodiment, a deflagration combustion process occurs within combustion chamber 140 at a constant pressure condition. In alternative embodiments, supplemental combustor 111 includes any combustion chamber that enables supplemental combustor 111 to operate as described herein. For example, in some embodiments, supplemental combustor 111 is configured for a detonation combustion process, such as a rotating detonation combustion process, to occur within combustion chamber 140.

During operation, supplemental combustor 111 receives combustion products, including compressed gas and fuel, from primary combustor 108 (shown in FIG. 1). Because the combustion products are substantially mixed, supplemental combustor 111 does not require a mixing element. In addition, supplemental combustor 111 receives additional fuel from a fuel supply 142. In some embodiments, fuel is provided to combustion chamber 140 through a plurality of small openings spaced about combustion chamber 140. An ignitor 144 ignites the compressed gas and fuel to initiate a deflagration process within combustion chamber 140. Combustion products from the deflagration process travel along combustion chamber 140 and exit supplemental combustor 111. Accordingly, in the exemplary embodiment, supplemental combustor 111 acts as a reburn combustor and processes combustion products from primary combustor 108 to remove unburnt fuel in the combustion products. As a result, the efficiency of power generation system 100 is increased. Also, supplemental combustor 111 increases the pressure of fluid flow. In addition, supplemental combustor 111 reduces gas emissions, such as carbon monoxide and nitrogen oxides. For example, in some embodiments, supplemental combustor 111 reduces emissions of nitrogen oxides to less than about 50 parts per million. In alternative embodiments, supplemental combustor 111 performs any combustion process that enables power generation system 100 (shown in FIG. 1) to operate as described herein. For example, in some embodiments, supplemental combustor 111 includes a detonation chamber and is configured to provide a detonation combustion process. In such embodiments, supplemental combustor 111 is provided a dilution flow to dilute the combustion products and facilitate the detonation process.

In reference to FIGS. 2 and 3, in the exemplary embodiment, supplemental combustor 111 facilitates a longer residence time of fluid flow within primary combustor 108, which increases the combustion efficiency of primary combustor 108. In particular, supplemental combustor 111 removes at least some gas emissions from combustion products of primary combustor 108. The amounts of emissions are directly proportional to the residence time of combustion products within combustion chamber 126. As the residence time increases, the amounts of emissions are increased. Primary combustor 108 is able to have a longer residence time because supplemental combustor 111 removes emissions from the combustion products. The residence time is at least partially determined by the size of combustion chamber 126. For example, increasing the size of combustion chamber 126 increases the residence time of primary combustor 108. In alternative embodiments, primary combustor 108 has any residence time that enables power generation system 100 (shown in FIG. 1) to operate as described herein.

In reference to FIGS. 1-3, a method of operating combined cycle power generation system 100 includes directing pressurized fluid flow into combustion chamber 126 of primary combustor 108. The pressurized fluid flow includes a mixture of fuel and air. Ignitor 128 is used to ignite the pressurized fluid flow and initiate a rotating detonation process within combustion chamber 126. The method also includes directing combustion products from combustion chamber 126 of primary combustor 108 towards combustion chamber 140 of supplemental combustor 111 and initiating a combustion process within combustion chamber 140 of supplemental combustor 111. The method further includes directing combustion products from combustion chamber 140 of supplemental combustor 111 towards first turbine 110 and/or second turbine 113. In some embodiments, fuel is channeled into combustion chamber 140 to support the combustion process within combustion chamber 140. In further embodiments, the combustion process within combustion chamber 140 includes, without limitation, any of the following: a deflagration process, a pulse detonation process, and a rotating detonation process.

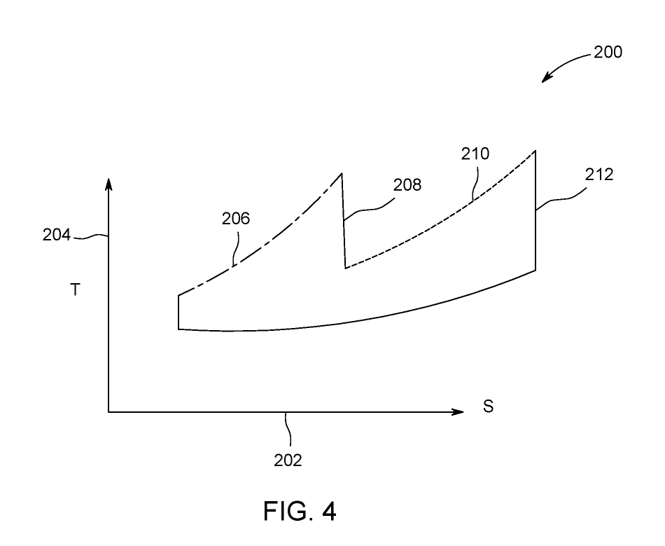

FIG. 4 is an exemplary graphical view, i.e., graph 200, of temperature vs. entropy for power generation system 100 (shown in FIG. 1). Graph 200 shows temperature and entropy changes of fluid flow through power generation system 100. In particular, graph 200 shows temperature increases during combustion processes of primary combustor 108 (shown in FIG. 1) and supplemental combustor 111 (shown in FIG. 1). Graph 200 includes a unitless x-axis 202 representative of entropy of fluid flow through power generation system 100. Graph 200 also includes a unitless y-axis 204 representative of temperature of fluid flow through power generation system 100. Graph 200 further includes a first curve 206, a second curve 208, a third curve 210, and a fourth curve 212.

In reference to FIGS. 1 and 4, first curve 206 represents fluid flow through primary combustor 108. Second curve 208 represents fluid flow through first turbine 110. Third curve 210 represents fluid flow through supplemental combustor 111. Fourth curve 212 represents fluid flow through second turbine 113. Along first curve 206, the fluid flow increases in temperature and entropy due to the combustion process within primary combustor 108. Along second curve 208, the fluid flow decreases in temperature due to the decrease in pressure and expansion of fluid flow within first turbine 110. Along third curve 210, the fluid flow increases in temperature and entropy due to the combustion process within supplemental combustor 111. Along fourth curve 212, the fluid flow decreases in temperature due to the decrease in pressure and expansion of fluid flow through second turbine 113. Third curve 210 has a maximum temperature that is greater than a maximum temperature of first curve 206 because supplemental combustor 111 further combusts the combustion products of primary combustor 108 and increases the temperature of fluid flow. As a result, power generation system 100 has an increased operating efficiency and at least some emissions, such as carbon monoxide and nitrogen oxides, are reduced. Accordingly, supplemental combustor 111 facilitates power generation system 100 having the increased performance of a rotating detonation engine yet obtaining substantially the same operating efficiency as a system including a constant pressure combustor. For example, in some embodiments, power generation system 100 has a combustion efficiency of greater than 99%.

The above-described embodiments provide a turbine engine including a primary combustor and a supplemental combustor. The primary combustor includes a detonation chamber for rotating detonation combustion. In particular, during operation, detonations continuously travel around the detonation chamber and produce near constant volume combustion within the combustion chamber of the primary combustor. The supplemental combustor receives combustion products from the primary combustor and performs a supplemental combustion process. As a result, the combustion efficiency of the turbine engine is increased because the supplemental combustor burns unburnt fuel in the combustion products emitted by the primary combustor.

An exemplary technical effect of the methods, systems, and apparatus described herein includes at least one of: (a) increasing the efficiency of rotating detonation engines; (b) increasing pressure of fluid flow through rotating detonation engines; (c) increasing power production of rotating detonation engines; (d) increasing the combustion efficiency of rotating detonation combustors; and (e) reducing gas emissions (such as nitrogen oxides, carbon oxides, and unburned hydro-carbons (UHC)) from the rotating detonation engines.

Exemplary embodiments of methods, systems, and apparatus for a gas turbine engine are not limited to the specific embodiments described herein, but rather, components of systems and steps of the methods may be utilized independently and separately from other components and steps described herein. For example, the methods may also be used in combination with other combustors, and are not limited to practice with only the gas turbine engines and methods as described herein. Rather, the exemplary embodiment can be implemented and utilized in connection with many other applications, equipment, and systems that may benefit from the advantages described herein.

Although specific features of various embodiments of the disclosure may be shown in some drawings and not in others, this is for convenience only. In accordance with the principles of the disclosure, any feature of a drawing may be referenced and claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A turbine engine comprising:
at least one compressor configured to increase pressure of a fluid flow;
a primary combustor coupled in flow communication with said at least one compressor, said primary combustor configured to receive pressurized fluid flow from said at least one compressor, said primary combustor including a housing defining at least one combustion chamber, said primary combustor configured for a rotating detonation process to occur within said at least one combustion chamber;
at least one supplemental combustor coupled in flow communication with said primary combustor, said at least one supplemental combustor configured to receive combustion products and perform a combustion operation; and
a turbine assembly coupled in flow communication with said at least one supplemental combustor, said turbine assembly configured to receive combustion products from said at least one supplemental combustor.

2. The turbine engine in accordance with claim 1, wherein said turbine assembly comprises a first turbine and a second turbine, said at least one supplemental combustor coupled to said turbine assembly between said first turbine and said second turbine.

3. The turbine engine in accordance with claim 1, wherein said at least one supplemental combustor is coupled between said primary combustor and said turbine assembly.

4. The turbine engine in accordance with claim 1, wherein said at least one supplemental combustor includes a supplemental combustor housing defining at least one supplemental combustion chamber, wherein said at least one supplemental combustor is configured to perform a combustion operation at constant pressure conditions within said supplemental combustor housing.

5. The turbine engine in accordance with claim 1, wherein said at least one supplemental combustor includes a supplemental combustor housing defining at least one supplemental combustion chamber, wherein said at least one supplemental combustor is configured for a detonation combustion process to occur within said at least one supplemental combustion chamber.

6. The turbine engine in accordance with claim 5, wherein said at least one supplemental combustor is coupled to said primary combustor to form a multi-stage combustor assembly.

7. The turbine engine in accordance with claim 1, wherein said at least one compressor comprises a primary compressor and a boost compressor, said primary compressor configured to channel pressurized fluid flow towards said primary combustor, said boost compressor configured to channel pressurized fluid flow towards said turbine assembly.

8. The turbine engine in accordance with claim 1, wherein said primary combustor further includes a mixing element to provide a mixture of fuel and air to said at least one combustion chamber.

9. The turbine engine in accordance with claim 1 further comprising a fuel supply coupled to said at least one supplemental combustor to provide fuel to said at least one supplemental combustor.

10. A power generation system comprising
at least one compressor configured to increase pressure of a fluid flow;
a primary combustor coupled in flow communication with said at least one compressor, said primary combustor configured to receive pressurized fluid flow from said at least one compressor, said primary combustor including a housing defining at least one combustion chamber, said primary combustor configured for a rotating detonation process to occur within said at least one combustion chamber;
a first turbine coupled in flow communication with said primary combustor, said first turbine configured to receive combustion flow from said primary combustor;
at least one supplemental combustor coupled in flow communication with said first turbine, said at least one supplemental combustor configured to receive exhaust flow from said first turbine and perform a combustion operation; and
a second turbine coupled in flow communication with said at least one supplemental combustor, said turbine configured to receive combustion flow from said at least one supplemental combustor.

11. The power generation system in accordance with claim 10, wherein said at least one supplemental combustor includes a supplemental combustor housing defining at least one supplemental combustion chamber, wherein said at least one supplemental combustor is configured for a constant volume combustion process to occur within said at least one supplemental combustion chamber at constant pressure conditions.

12. The power generation system in accordance with claim 10, wherein said at least one supplemental combustor includes a supplemental combustor housing defining at least one supplemental combustion chamber, wherein said at least one supplemental combustor is configured for a detonation combustion process to occur within said at least one supplemental combustion chamber.

13. The power generation system in accordance with claim 10, wherein said at least one compressor comprises a primary compressor and a boost compressor, said primary compressor configured to channel pressurized fluid flow towards said primary combustor, said boost compressor configured to channel pressurized fluid flow towards said turbine assembly.

14. The power generation system in accordance with claim 10 further comprising a heat recovery steam generator coupled in flow communication with said first turbine and said second turbine, said heat recovery steam generator configured to receive exhaust flow from said first turbine and channel steam to said second turbine.

15. A method of operating a turbine engine, the turbine engine including a primary combustor and a supplemental combustor, said method comprising:
directing a pressurized fluid flow into at least one combustion chamber of the primary combustor;
initiating a rotating detonation process within the at least one combustion chamber;
directing combustion products from the at least one combustion chamber of the primary combustor toward at least one combustion chamber of the supplemental combustor;
initiating a combustion process within the at least one combustion chamber of the supplemental combustor; and
directing combustion products from the at least one combustion chamber of the supplemental combustor toward a turbine assembly of the turbine engine.

16. The method in accordance with claim 15, wherein the turbine assembly includes a first turbine and a second turbine, and wherein directing combustion products from the combustion process toward the turbine assembly of the turbine engine comprises directing combustion products from the combustion process toward the second turbine.

17. The method in accordance with claim 16, wherein directing combustion products from the at least one combustion chamber of the primary combustor toward at least one combustion chamber of the supplemental combustor comprises directing combustion products from the at least one combustion chamber of the primary combustor through the first turbine toward the at least one combustion chamber of the supplemental combustor.

18. The method in accordance with claim 15 further comprising channeling fuel into the at least one combustion chamber of the supplemental combustor.

19. The method in accordance with claim 15, wherein initiating a combustion process within the at least one combustion chamber of the supplemental combustor comprises initiating a deflagration combustion process within the at least one combustion chamber of the supplemental combustor.

20. The method in accordance with claim 15, wherein initiating a combustion process within the at least one combustion chamber of the supplemental combustor comprises initiating a rotating detonation process within the at least one combustion chamber of the supplemental combustor.
